(19) United States
(12) Patent Application Publication
(10) Pub. No.: US 2013/0185094 A1
(43) Pub. Date: Jul. 18, 2013

(54) Automated ICD-9 To ICD-10 Code Conversion System

(71) Applicants: Ananta Mukerji, Chino Hills, CA (US); Avijit Datta, Chatsworth, CA (US)

(72) Inventors: Ananta Mukerji, Chino Hills, CA (US); Avijit Datta, Chatsworth, CA (US)

(73) Assignee: AVIANA GLOBAL TECHNOLOGIES, INC., Brea, CA (US)

(21) Appl. No.: 13/469,173

(22) Filed: May 11, 2012

Related U.S. Application Data
(60) Provisional application No. 61/587,984, filed on Jan. 18, 2012.

(51) Int. Cl. G06Q 50/24

(52) U.S. Cl. 705/3

(57) ABSTRACT

Code conversion from ICD-9 data to ICD-10 codes is semi-automatic. Codes that cannot readily be converted in a fully automatic environment are referred to an interactive code assignment engine, which retrieves information from clinical databases to suggest codes to a human worker.

### PRIORITY CLAIM

This application claims priority to U.S. provisional application Ser No. 61/587984, filed Jan. 18, 2012. The priority application, as well as all other extrinsic references discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is healthcare analytics.

### BACKGROUND

The International Classification of Diseases (ICD) coding scheme is used worldwide for analytics and reporting related to diseases and their associated medical procedures. Every “first world” nation currently uses Version 10 of the ICD coding scheme (ICD-10), except for the United States, which still uses the out-dated Version 9 (ICD-9). The Center for Medicare and Medicaid Services (CMS) of the United States federal government has mandated that all healthcare payers and providers (collectively “companies”) transition from ICD-9 to ICD-10 coding effective Oct. 1, 2013. As US healthcare companies are busy incorporating system and process changes to meet this deadline, there is a challenge that is frequently missed in most ICD-10 transition plans:

ICD-10 transition plans are focusing on coding new transactions using the new ICD-10 scheme, and not on converting (i.e., re-coding) existing legacy transactions that have already been coded as ICD-9 into the new ICD-10 coding scheme.

However, post transition, converted legacy data will be required in order to model contracts, to analyze reimbursement trends and to report on quality indicators. Inaccurate information will leave companies exposed both financially as well as in the reporting of quality indicators. So there is a strong need to convert existing legacy data from ICD-9 to ICD-10.

There is no easy way to accurately map legacy ICD-9 code based data to ICD-10. The ICD-9 scheme has approximately 17,000 codes, whereas the ICD-10 scheme has over 160,000 codes, and unambiguous “1-to 1” mappings are possible for only about 40% of the existing ICD-9 codes using the GEMS mappings provided by CMS. The remaining ICD-9 codes either have no corresponding ICD-10 codes, or have to be selected from many available choices (“1-to-many”), where “many” may range from 2 choices to over 1,000 possible choices.

ICD Code conversion tools offered by other vendors tend to be (a) restricted to a small code set within their applications alone, or (b) focus on coding new and current transactions directly into ICD-10, or (3) are “interactive” and not “automated” in their approach (e.g., “this code has these possible available options, pick one”).

Most healthcare companies will be seriously handicapped as this regulation is implemented, as “automated” or software -based capabilities are not available to translate existing data from ICD-9 to ICD-10 with a high degree of accuracy. Automated translation is not easy, because it would involve (1) complicated data aggregation from multiple disparate source systems such as electronic health records, laboratory, surgery, ICU, NICU/PICU, emergency room, radiology, surgery, pharmacy, etc; (2) multiple data formats including proprietary data stores and file systems, relational databases, text files, DOC files, PDF documents, HL7 data streams to name a few possibilities; and (3) complex logic, natural language processing and other analytic capabilities in order to semantically decode the different data elements to meaningful code mappings.

The only alternative is to manually re-code data from pre-ICD-10 era by employing additional coding resources at an estimated additional cost of over $400,000 or more per year's worth of ICD-9 data for a typical 200 bed hospital.

Although the above references may provide adequate approaches for specific situations, they fail to fully address the automated conversion of ICD-9 codes to corresponding ICD-10 codes in existing legacy transactions.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Thus, there is still a need for an automated system to convert ICD-9 codes to ICD-10 codes.

### SUMMARY OF THE INVENTION

The inventive subject matter provides apparatus, systems and methods that use a code conversion engine to apply conversion rules to information from patient clinical records to assist in converting ICD-9 codes to ICD-10 codes that have a one-to-many correlation.

Ideally, the code conversion engine processes incoming ICD-9 data to ICD-10 based on the stored conversion rules and job scheduling rules. One or more libraries can be used to store the conversion rules, the data processing rules and schedules, authorized user authentication and access control data, as well as other control data for effective operation of the system.

One class of preferred embodiments further comprises an incoming data engine, an interface for individuals to interact with the system, an output data engine, and a reporting engine. The incoming data engine preferably processes and stores incoming source data, as well as the routines for data extraction, transformation and loading into the system. The output data engine can manage and provide converted ICD-10 data, along with any unconverted ICD-9 data, to the customer using templates and rules stored in the library. When desired, the reporting engine can provide a wide variety of reports pertaining to the inputs, processing status and outputs to the customer according to their desired format.

There are likely also multiple interfaces, which collectively allow users to manage conversion rules, manage data, automate code conversion cycles, and interactively resolve open issues pertaining to code conversion subject to authentication and access control rules stored in the library.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions.

Various objects, features, aspects and advantages of the inventive subject matter will become more apparent from the following detailed description of preferred embodiments, along with the accompanying drawing figure(s).

### BRIEF DESCRIPTION OF THE DRAWING

FIG. 1 represents three different approaches that a healthcare company can adopt vis-à-vis migration from ICD-9 to ICD-10.

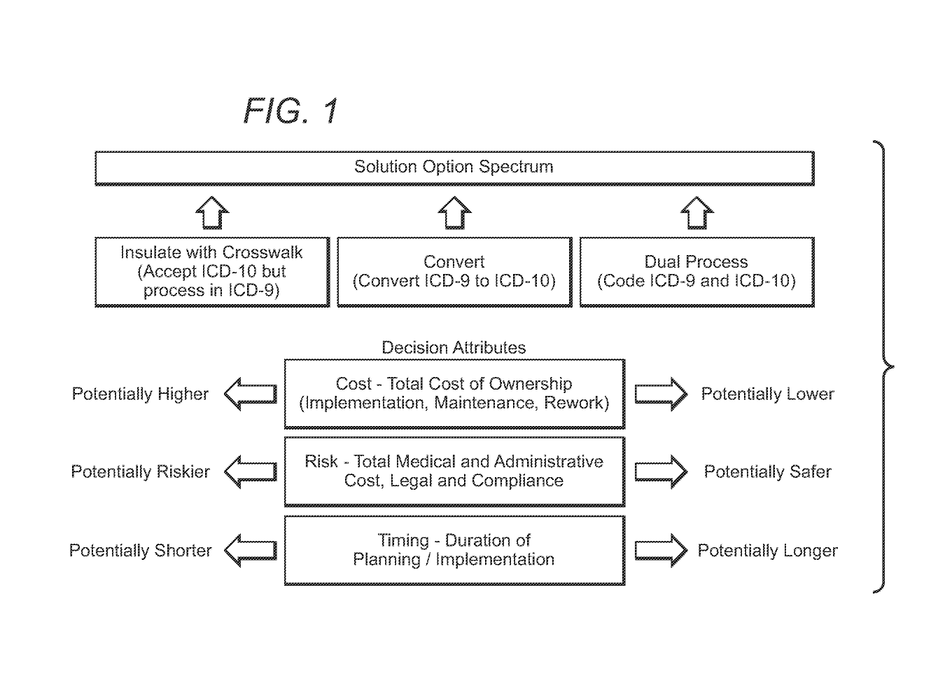

FIG. 2 presents a diagrammatic overview of ICD9₂10™ Converter, a possible ICD-9 to ICD-10 code conversion system.

### DETAILED DESCRIPTION

A. Overview

ICD-9 data can include various forms of medical transactions, including initial and final or updated diagnoses, medical procedures that were performed on a patient as the patient progressed through the episode of care described by the current diagnosis code(s), and subsequent financial information pertaining to the payment for the services performed. The associated clinical data can include numeric (structured) as well as textual (unstructured) data from disparate systems such as the electronic health record system (EHR), or those associated with laboratory services, surgery/operating rooms, ICU, NICU/PICU, emergency room, radiology, pharmacy, etc.

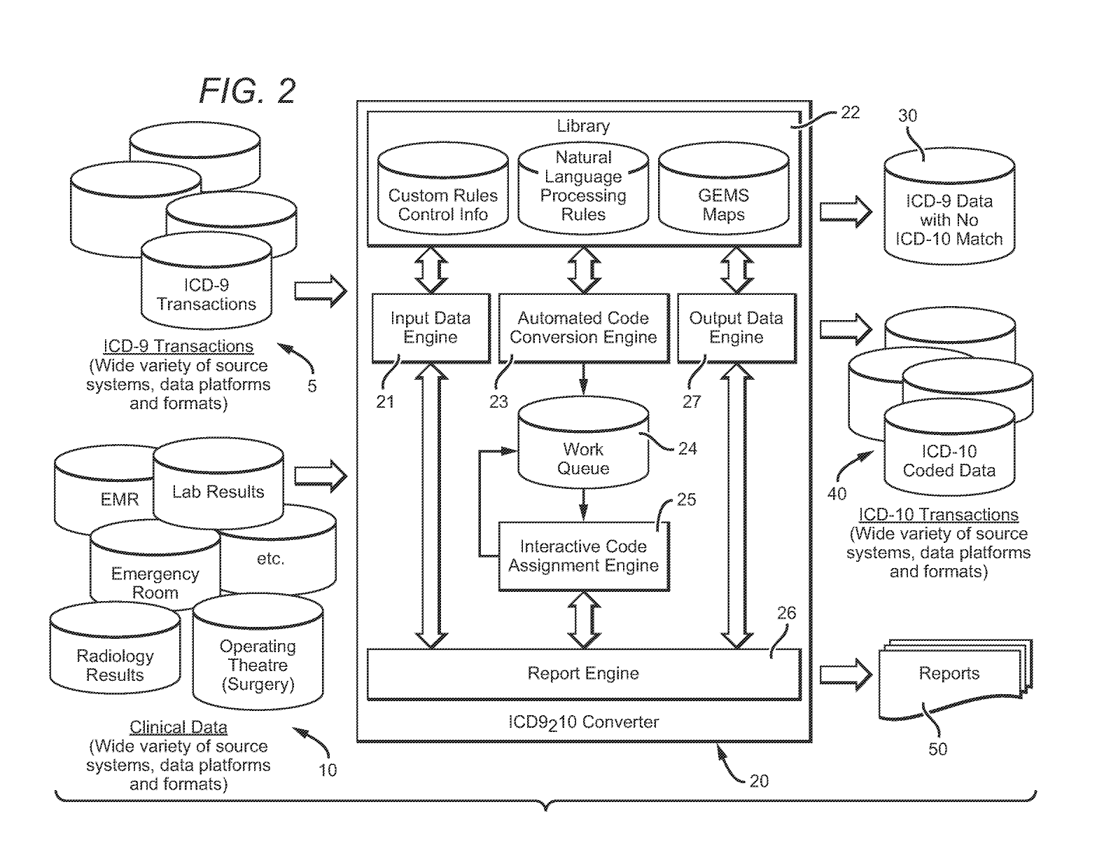

The following sections discuss aspects of a preferred ICD-9 to ICD-10 code conversion system. One should note that the features of FIG. 2 represent data or process workflows as managed by one or more servers. For example, the libraries present databases for storing input and output data templates, ICD-9 to ICD-10 conversion rules, report definition templates, etc. Similarly, the system can include one or more interfaces as portals through which customers or other designated individuals can access the system.

In general, the code converter 20 processes ICD-9 transactions 5, as well as patient data 10, to produce three categories of information, ICD-9 data with no ICD-10 match 30, ICD-10 coded data 40, and reports 50. The code converter 20 generally includes an input data engine 21, a library 22, an automated code conversion engine 23, a work queue 24, an interactive assignment engine 25, a report engine 26, and an output data engine 27.

B. Input Data Engine (21)

The input data engine 21 of a preferred proposed ICD-9 to ICD-10 code conversion system accepts incoming ICD-9 data 5 and associated clinical data from a variety of different source systems 10 and in several different formats, using templates and rules stored in the library 26.

C. Automated Code Conversion Engine (23)

The loaded incoming ICD-9 data is converted into corresponding ICD-10 data by the automated code conversion engine 23, which interrogates the available clinical documentation from the customer's existing operational systems to automatically select the appropriate ICD-10 code from amongst the multiple available options. The needed rules and data mappings are stored in the library 26, and accessed as needed. The mappings performed by the automated code conversion engine 23 are well established, and are publically available through the General Equivalence Mapping (GEM) files published by the Centers for Medicare & Medicaid Services (CMS). See https://www.cms.gov/ICD10/Downloads/GEMs-CrosswalksTechnicalFAQ.pdf, and at the CMS website, http://www.cms.gov/ICD10/13 2010 ICD1OPCS.asp.

D. Interactive Code Conversion Engine (25)

Partially processed data, such as when the automated code conversion engine 22 has eliminated some of the possible choices, but has been unable to resolve all ambiguities, are placed in the work queue. The items in this work queue are interactively processed by authorized individuals using the interactive code conversion engine 25.

The user does not have to know the specific ICD-10 code needed, but rather is provided with choices and questions as determined by the interactive code conversion engine 25, which behaves as a “smart” assistant and works behind the scene to eliminate inappropriate options, or to prompt with possible matches.

E. Reporting Engine (Item 26)

The Reporting Engine is designed to provide a wide variety of reports to the customer using report definitions and other control information stored in the library 22.

Designated customer personnel, or other authorized users can review the processed data and accept or reject the automated and assisted ICD-9 to ICD-10 conversions, and this information can be fed back to the automated code conversion engine 23 to improve its performance in successive iterations.

Output Data Engine (27)

The output data engine 27 is used to provide the converted ICD-10 data, as well as the unconverted data to the customer, using formats desired by them and stored in the library 22.

Outputs (30, 40, 50)

The goal, of course, is to properly convert all the codes either automatically using the automated code conversion engine 23, or with user input through the interactive code assignment engine 25. Such proper converted codes are stored in the ICD-10 coded data store 40. It is contemplated, however, that some ICD-9 codes will be particularly resistant to conversion, possibly because they were miscoded in the first place, and that miscoding was identified during comparison with clinical data, and possibly because there is simply no appropriate ICD-10 code. In any event such non converted codes can advantageously be stored in the store identified in the drawing as ICD-9 with no ICD-10 match 30. It is also contemplated that reports 50 will be generated that detail and/or summarize relevant parameters of the conversion process, including statistics such as how many codes were converted automatically, how many using human interaction, and how many were not converted.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A system for assisting a user to utilize patient clinical records to convert from ICD-9 codes to ICD-10 codes, the system comprising:
a computing device having a processor and a computer readable media;
a plurality of conversion rules stored on the computer readable media;
an automated code conversion engine comprising a first set of executable instructions that are configured to apply the plurality of conversion rules to produce an automatic mapping of individual ones of the ICD-9 codes to ICD-10 codes;
an interactive conversion engine configured to apply natural language processing to automatically data mine the patient clinical records for information other than diagnoses, and to use the information to recommend at least one likely ICD-10 codes in at least some instances where the automatic mapping is unable to resolve all ambiguities; and
a first interface through which the user can interactively resolve open issues pertaining to the code conversion by selecting a particular ICD-10 thought to be appropriate from among the recommended ICD-10 codes.

2. The system of claim 1, further comprising at least one of authentication and access control rules that affect human resolution of open issues.

3. The system of claim 1, further comprising a second interface through which a second human can schedule code conversion jobs.

4. The system of claim 1, further comprising an incoming data engine that processes and stores incoming source data, as well as the routines for data extraction, transformation and loading into the system.

5. The system of claim 1, further comprising an incoming data engine that manages and provides converted ICD-10 data, along with any unconverted ICD-9 data, to the user using templates and rules stored in a library.

6. The system of claim 1, wherein the information other than diagnoses comprises unstructured text data.

7. The system of claim 6, wherein the unstructured text data comprises laboratory services data.

8. The system of claim 6, wherein the unstructured text data comprises at least one of surgery/operating rooms data, ICU data, NICU/PICU data, emergency room data.

9. The system of claim 6, wherein the unstructured text data comprises radiology data.

10. The system of claim 6, wherein the unstructured text data comprises pharmacy data.
